(19) United States
(12) Patent Application Publication
(10) Pub. No.: US 2023/0301276 A1
(43) Pub. Date: Sep. 28, 2023

(54) ANIMAL TRAINING DEVICE

(71) Applicant: Shannon East, San Jose, CA (US)

(72) Inventor: Shannon East, San Jose, CA (US)

(21) Appl. No.: 17/702,241

(22) Filed: Mar. 23, 2022

(51) Int. Cl. A01K 27/00

(52) U.S. Cl. CPC A01K 27/009; A01K 27/001

(57) ABSTRACT

An animal training device removably connected to a collar of a pet, the animal training device including a main body, a speaker disposed on at least a portion of the main body to emit at least one voice command therefrom, and a microphone disposed on at least a portion of the main body to receive at least one audio input therein.

### BACKGROUND

### 1. Field

The present general inventive concept relates generally to animals, and particularly, to an animal training device.

### 2. Description of the Related Art

A pet is an animal companion for many people. An owner of the pet often has different reasons for owning the pet, such as entertainment, companionship, working animal, and/or livestock. However, pets have a wide range of personalities, which includes acceptable and unacceptable behaviors.

Animal training is a method of changing behaviors of the pet, but can be a difficult challenge for some owners. In recent years, some pet owners have used shock and/or vibration collars as a means of behavioral modification. Yet, shock and/or vibration collars pose a risk of causing injury to the pet.

Therefore, there is a need for an animal training device that does not cause shock and/or vibration, but effectively corrects unacceptable behavior and reinforces acceptable behavior.

### SUMMARY

The present general inventive concept provides an animal training device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an animal training device removably connected to a collar of a pet, the animal training device including a main body, a speaker disposed on at least a portion of the main body to emit at least one voice command therefrom, and a microphone disposed on at least a portion of the main body to receive at least one audio input therein.

The main body may include a first section disposed on at least a portion of a first side of the main body, and a second section disposed on at least a portion of a second side of the main body opposite with respect to the first side.

The second section may be distanced away from the first section.

The animal training device may further include an illumination unit disposed around at least a portion of a perimeter of the main body to illuminate a surrounding area of the main body.

The illumination unit may be disposed between the first section and the second section.

The animal training device may further include a control unit disposed within at least a portion of the main body to store at least one prerecorded voice command thereon, such that the speaker emits the at least one prerecorded voice command in response to the control unit determining at least one of a detected behavior of the pet and at least one sound received from the pet through the microphone.

The speaker may emit disapproving voice commands in response to the control unit determining unacceptable behavior by the pet and approving voice commands in response to the control unit determining acceptable behavior by the pet.

The animal training device may further include a communication unit disposed within at least a portion of the main body to receive at least one setting command.

The animal training device may further include a global positioning system disposed within at least a portion of the main body to track a position of the main body.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1A illustrates a front perspective view of an animal training device, according to an exemplary embodiment of the present general inventive concept;

FIG. 1B illustrates a rear perspective view of the animal training device, according to an exemplary embodiment of the present general inventive concept; and

FIG. 2 illustrates a perspective view of the animal training device as disposed on a collar, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Animal Training Device 100
Main Body 110
First Section 111
Second Section 112
Speaker 120
Microphone 130
Illumination Unit 140
Control Unit 150
Communication Unit 160
Global Positioning System (GPS) 170
Power Source 180
Connecting Clip 190

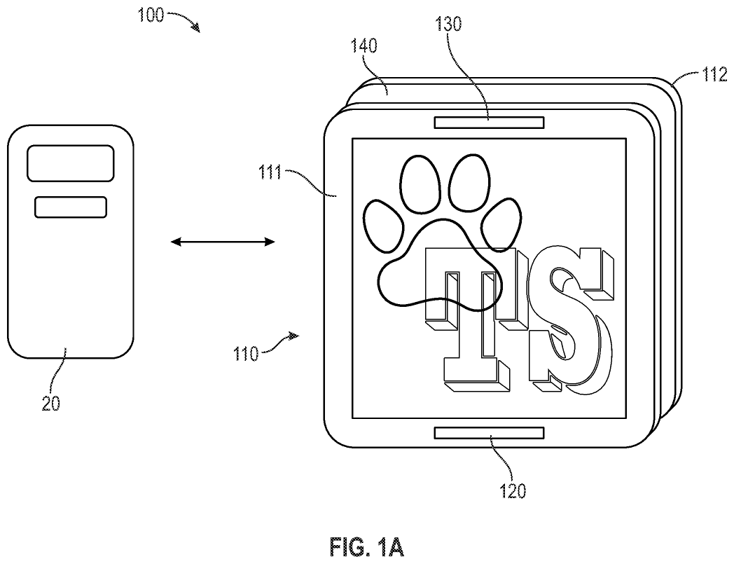

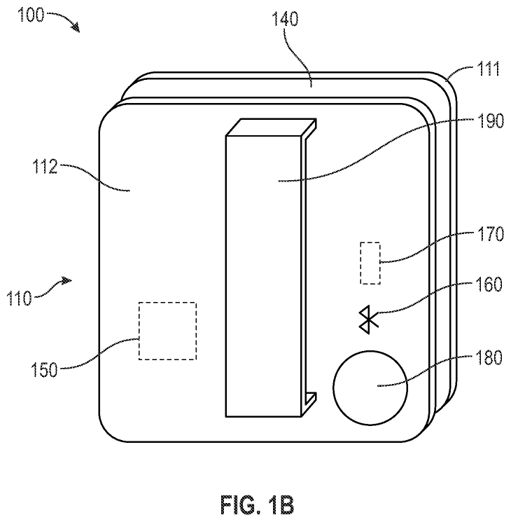

FIG. 1A illustrates a front perspective view of an animal training device 100, according to an exemplary embodiment of the present general inventive concept.

FIG. 1B illustrates a rear perspective view of the animal training device 100, according to an exemplary embodiment of the present general inventive concept.

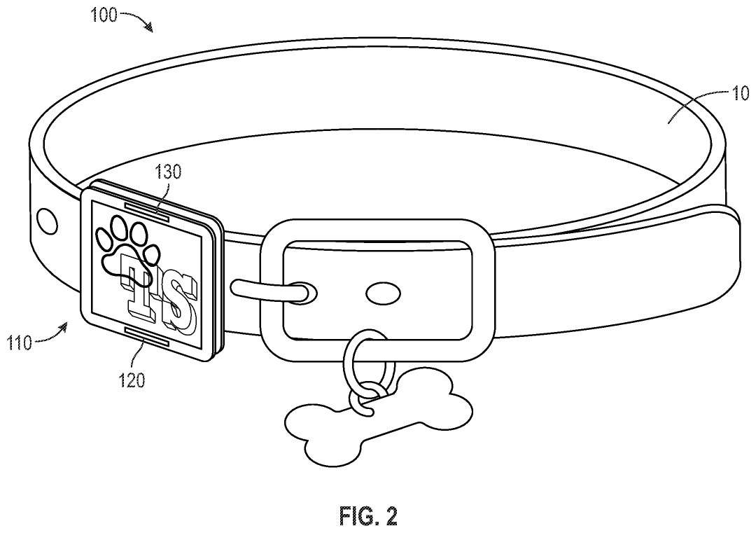

FIG. 2 illustrates a perspective view of the animal training device 100 as disposed on a collar 10, according to an exemplary embodiment of the present general inventive concept.

The animal training device 100 may be constructed from at least one of metal, plastic, wood, glass, and rubber, etc., but is not limited thereto. The animal training device 100 may be waterproof.

Referring to FIGS. 1A through 2, the animal training device 100 may include a main body 110, a speaker 120, microphone 130, an illumination unit 140, a control unit 150, a communication unit 160, a global positioning system (GPS) 170, a power source 180, and a connecting clip 190, but is not limited thereto.

Referring again to FIGS. 1A through 2, the main body 110 is illustrated to have a rounded rectangular prism shape. However, the main body 110 may be rectangular, circular, cylindrical, triangular, pentagonal, hexagonal, heptagonal, octagonal, or any other shape known to one of ordinary skill in the art, but is not limited thereto.

The main body 110 may be removably connected to at least a portion of a collar 10 worn by a pet. Moreover, the main body 110 may be suspended from the collar 10 while connected to the collar 10. Also, the main body 110 may be constructed as a pet tag.

The main body 110 may include a first section 111 and a second section 112, but is not limited thereto.

The first section 111 may be disposed on at least a portion of a first side of the main body 110.

The second section 112 may be disposed on at least a portion of a second side of the main body 110 opposite with respect to the first side. The second section 112 may have a size (e.g., a length, a width, a height) equivalent to a size of the first section 111. The second section 112 may be disposed on at least a portion of the first section 111. Alternatively, the second section 112 may be distanced away from the first section 111.

The speaker 120 may be disposed on at least a portion of the first section 111. The speaker 120 may emit at least one sound therefrom. For example, the speaker 120 may emit at least one voice command corresponding to a voice of an owner.

The microphone 130 may be disposed on at least a portion of the first section 111. The microphone 130 may receive and/or record at least one audio input therein. For example, the microphone 130 may record the at least one voice command corresponding to the voice of the owner therein.

The illumination unit 140 may include an incandescent bulb, a light-emitting diode (LED), a matrix of small lights, a light strip, and a fluorescent light, but is not limited thereto.

The illumination unit 140 may be disposed around at least a portion of a perimeter of the main body 110. Alternatively, the illumination unit 140 may be disposed between the first section 111 and/or the second section 112. As such, the illumination unit 140 may separate the first section 111 from the second section 112. The illumination unit 140 may illuminate a surrounding area of the main body 110. Furthermore, the illumination unit 140 may illuminate, flash, blink, and/or strobe in response to the speaker 120 emitting the at least one sound therefrom.

The control unit 150 may include a sensor, a processing unit, and a storage unit, but is not limited thereto.

The processing unit of the control unit 150 (or central processing unit, CPU) may include electronic circuitry to carry out instructions of a computer program by performing basic arithmetic, logical, control and input/output (I/O) operations specified by the instructions. The processing unit of the control unit 150 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit of the control unit 150 may also include a microprocessor and a microcontroller.

The storage unit of the control unit 150 may include a random access memory (RAM), a read-only memory (ROM), a hard disk, a flash drive, a database connected to the Internet, cloud-based storage, Internet-based storage, or any other type of storage unit.

The processing unit of the control unit 150 may access the Internet via the communication unit 160 to allow the user to access a website, and/or may allow a mobile application and/or the software application to be executed using the processing unit. For ease of description, the mobile and/or the software application will be hereinafter referred to as an app. The app may be downloaded from the Internet to be stored on the storage unit of the control unit 150.

The control unit 150 may be disposed within at least a portion of the main body 110 and/or connected to the speaker 120, the microphone 130, and/or the illumination unit 140. The processing unit of the control unit 150 executing the app may store the at least one voice command received by the microphone 130 onto the storage unit of the control unit 150. Moreover, the processing unit of the control unit 150 executing the app may have a predetermined number of voice commands that may be recorded on the storage unit of the control unit 150. For example, the storage unit of the control unit 150 may store five voice commands, but more or less than five commands may be stored based on a preference of the user. As such, the storage unit of the control unit 150 may store at least one prerecorded voice command thereon.

Alternatively, the control unit 150 may store a plurality of other sounds, such as a short beep, a long beep, a high frequency sound, a low frequency sound, a tone and/or a pattern of sounds predetermined to capture attention of the pet, and/or any combination of the plurality of other sounds.

Furthermore, the control unit 150 may send a command to the speaker 120 to emit the at least one voice command from the at least one prerecorded voice command stored on the storage unit of the control unit 150. Additionally, the processing unit of the control unit 150 executing the app may send the command to the speaker 120 to emit the at least one voice command based on a detected behavior of the pet (e.g., movements, actions) by the sensor of the control unit 150 and/or at least one sound received from the pet through the microphone 130. In other words, the processing unit of the control unit 150 executing the app may emit disapproving voice commands (e.g., “No!”, “Bad dog!”, “Bad cat!”, etc.) based on unacceptable behavior by the pet (e.g., running onto the street, peeing in the house, making a mess) and/or approving voice commands (e.g., “Good job!”, “Good dog!”, “Yes!”, etc.) based on acceptable behavior by the pet (e.g., peeing only outside, being quiet while the owner is eating, obeying commands). Accordingly, the control unit 150 may be programmed by the owner to respond based on behaviors of the pet.

Alternatively, the control unit 150 may allow real-time interaction between the owner and the pet. Accordingly, the control unit 150 may control training of the pet using sound without having to shock and/or use vibration to interrupt behaviors of the pet.

The communication unit 160 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, Firewire, and Ethernet.

The communication unit 160 may be disposed within at least a portion of the main body 110 and/or connected to the control unit 150. The communication unit 160 may transmit a signal to an external device 20, such as a mobile device, a cell phone, a tablet computer, a laptop computer, a desktop computer, and/or a personal digital assistant (PDA). Alternatively, the communication unit 160 may receive at least one setting command from the external device 20 to control the speaker 120, the microphone 130, the illumination unit 140, and/or the control unit 150.

The external device 20 may download the app to interact with and control functionality (e.g., settings) of the control unit 150. For example, the external device 20 may program a number of voice commands, the acceptable behavior, and/or the unacceptable behavior. Also, the external device 20 may be used for real-time interaction between the owner and the pet, such that the external device 20 may receive at least one voice command thereon and transmit it to the communication unit 160, such that the control unit 150 sends the at least one voice command to be emitted from the speaker 120. Alternatively, the microphone 130 may be used to record the at least one voice command while using the external device 20. Furthermore, the external device 20 may set a volume level on the speaker 120, such as low, medium, and/or high. Specifically, low may be a lowest volume level and high is a highest volume level.

The GPS 170 may be disposed within at least a portion of the main body 110. The GPS 170 may track a position of the main body 110. Moreover, the external device 20 executing the app may receive a GPS signal from the GPS 170 to facilitate locating the main body 110. As such, the external device 20 executing the app may locate a position of the pet that may be lost and/or stolen.

The power source 180 may include a battery and a solar cell, but is not limited thereto.

The power source 180 may be disposed within at least a portion of the main body 110. The power source 180 may provide power to the speaker 120, the microphone 130, the illumination unit 140, the control unit 150, the communication unit 160, and/or the GPS 170.

The connecting clip 190 may be disposed on at least a portion of the second section 112. The connecting clip 190 may receive at least a portion of the collar 10 therein. As such, the connecting clip 190 may fasten the main body 110 to the collar 10.

Therefore, the animal training device 100 may correct unacceptable behavior and/or reinforce acceptable behavior using voice commands. Also, the animal training device 100 may provide more humane behavior adjustment by not using shock and/or vibration on the pet.

The present general inventive concept may include an animal training device 100 removably connected to a collar 10 of a pet, the animal training device 100 including a main body 110, a speaker 120 disposed on at least a portion of the main body 110 to emit at least one voice command therefrom, and a microphone 130 disposed on at least a portion of the main body 110 to receive at least one audio input therein.

The main body 110 may include a first section 111 disposed on at least a portion of a first side of the main body 110, and a second section 112 disposed on at least a portion of a second side of the main body 110 opposite with respect to the first side.

The second section 112 may be distanced away from the first section 111.

The animal training device 100 may further include an illumination unit 140 disposed around at least a portion of a perimeter of the main body 110 to illuminate a surrounding area of the main body 110.

The illumination unit 140 may be disposed between the first section 111 and the second section 112.

The animal training device 100 may further include a control unit 150 disposed within at least a portion of the main body 110 to store at least one prerecorded voice command thereon, such that the speaker 120 emits the at least one prerecorded voice command in response to the control unit 150 determining at least one of a detected behavior of the pet and at least one sound received from the pet through the microphone 130.

The speaker 120 may emit disapproving voice commands in response to the control unit 150 determining unacceptable behavior by the pet and approving voice commands in response to the control unit 150 determining acceptable behavior by the pet.

The animal training device 100 may further include a communication unit 160 disposed within at least a portion of the main body 110 to receive at least one setting command.

The animal training device 100 may further include a global positioning system 170 disposed within at least a portion of the main body 110 to track a position of the main body 110.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An animal training device removably connected to a collar of a pet, the animal training device comprising:
a main body;
a speaker disposed on at least a portion of the main body to emit at least one voice command therefrom; and
a microphone disposed on at least a portion of the main body to receive at least one audio input therein.

2. The animal training device of claim 1, wherein the main body comprises:
a first section disposed on at least a portion of a first side of the main body; and
a second section disposed on at least a portion of a second side of the main body opposite with respect to the first side.

3. The animal training device of claim 2, wherein the second section is distanced away from the first section.

4. The animal training device of claim 2, further comprising:
an illumination unit disposed around at least a portion of a perimeter of the main body to illuminate a surrounding area of the main body.

5. The animal training device of claim 4, wherein the illumination unit is disposed between the first section and the second section.

6. The animal training device of claim 1, further comprising:
a control unit disposed within at least a portion of the main body to store at least one prerecorded voice command thereon, such that the speaker emits the at least one prerecorded voice command in response to the control unit determining at least one of a detected behavior of the pet and at least one sound received from the pet through the microphone.

7. The animal training device of claim 6, wherein the speaker emits at least one disapproving voice command in response to the control unit determining unacceptable behavior by the pet and at least one approving voice command in response to the control unit determining acceptable behavior by the pet.

8. The animal training device of claim 1, further comprising:
a communication unit disposed within at least a portion of the main body to receive at least one setting command.

9. The animal training device of claim 1, further comprising:
a global positioning system disposed within at least a portion of the main body to track a position of the main body.
